(19) United States
(12) Patent Application Publication
(10) Pub. No.: US 2002/0144954 A1
(43) Pub. Date: Oct. 10, 2002

(54) Electrodeionization device and methods of use

(76) Inventors: John W. Arba, Bradford, MA (US); Paul Springthorpe, Flore (GB); Li-Shiang Liang, Harvard, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/954,986

(22) Filed: Sep. 18, 2001

Related U.S. Application Data
(60) Provisional application No. 60/236,276, filed on Sep. 28, 2000.

(51) Int. Cl. C02F 1/48

(52) U.S. Cl. 210/742; 210/748; 210/764; 210/774

(57) ABSTRACT

The purification system includes an electrodeionization device which can comprise one or a plurality of stages. The electrodeionization device can be constructed with a resilient sealing member forming a water-tight seal between rigid thermally and dimensionally stable compartment spacers. The construction of the electrodeionization device allows hot water cycling, which, in some cases, improves its efficiency and performance. Moreover, the hot water cycling may be used to sanitize the device to a pharmaceutically acceptable condition and, preferably, to meet at least minimum requirements according to U.S. Pharmacopoeia guidelines by inactivating any microorganisms.

### RELATED APPLICATION

This application claims the benefit of provisional application serial No. 60/236,276, filed Sep. 28, 2000, and entitled “Continuous Electrodeionization Module and System Design for Power Applications,” the entire contents of which are incorporated herein by reference.

### BACKGROUND OF THE INVENTION

1. Field of the Invention

The present invention relates to water purification and, more particularly, to water purification using an electrodeionization device and to sanitization and sealing of the electrodeionization device.

2. Description of the Related Art

Electrodeionization is a process for removing ionic or ionizable species from liquids using an electrically active medium and an electric field to influence ion transport. The electroactive medium may function to alternately collect and discharge ionizable species that facilitate the transport of ions by ionic or anionic substitution mechanisms. Electrodeionization devices can include media having permanent or temporary charge and can be operated to cause electrochemical reactions designed to achieve or enhance performance. These devices typically include an electrically active membrane such as a semipermeable or ion selective membrane.

An electrodeionization device typically includes alternating electroactive semipermeable anion and cation exchange membranes. Spaces between the membranes are configured to create liquid flow compartments with inlets and outlets. A transversely applied electric field is imposed by an external power source through electrodes at the boundaries of the membranes and compartments. Upon imposition of the electric field, ions in the liquid to be purified are attracted to their respective counter-electrodes. The adjoining compartments, bounded by ion selective membranes, become ionically enriched as a result of ion transport. Electrodeionization devices have been described by, for example, Giuffrida et al. in U.S. Pat. Nos. 4,632,745, 4,925,541, and 5,211,823; by Ganzi in U.S. Pat. Nos. 5,259,936, and 5,316,637; by Oren et al. in U.S. Pat. No. 5,154,809; and by Towe et al. in U.S. Pat. No. 6,235,166.

### SUMMARY OF THE INVENTION

The present invention provides a method for inactivating microorganisms in an electrodeionization device. The method comprises the steps of passing water through the electrodeionization device at a pharmaceutically acceptable sanitization temperature and maintaining the pharmaceutically acceptable sanitization temperature for a predetermined period of time.

In another embodiment, the present invention is directed to a water purification system. The water purification system comprises an electrodeionization device fluidly connected to a heating device and a controller for regulating a flow and temperature of water at a pharmaceutically acceptable level in the electrodeionization device.

In another embodiment, the present invention provides a method for disinfecting an electrodeionization device. The method comprises the step of passing a disinfecting solution at a temperature sufficient to inactivate any microorganisms in the electrodeionization device.

In another embodiment, the present invention is directed to an electrodeionization device. The electrodeionization device comprises a spacer constructed of a material that is dimensionally stable at a temperature that sanitizes the electrodeionization device for pharmaceutical service.

In another embodiment, the present invention provides a method for purifying water. The method comprises the steps of passing water to be purified through the electrodeionization device and passing water at a temperature greater than about 65° C. through the electrodeionization device for a predetermined period.

In another embodiment, the present invention is directed to an electrodeionization device. The electrodeionization device comprises a rigid depleting compartment spacer having a groove formed on a side thereon, a rigid concentrating compartment spacer that mates with the depleting compartment, and a resilient member disposed within the groove forming a water-tight seal between the depleting compartment and the concentrating compartment spacers.

In another embodiment, the present invention provides a method for purifying water. The method comprises the steps of passing water to be purified through an electrodeionization device comprising a depleting compartment spacer having a groove formed on a side thereon, a concentrating compartment spacer and a resilient member disposed within the groove forming a water-tight seal between the depleting compartment and the concentrating compartment spacers, and applying an electric field across the electrodeionization device.

In another embodiment, the present invention is directed to an electrodeionization device. The electrodeionization device comprises a depleting compartment spacer, a concentrating compartment spacer and a water-tight seal positioned between a depleting compartment and the concentrating compartment spacers. The water-tight seal comprises an elastomeric sealing member disposed within a groove formed on a surface of either the depleting compartment or the concentrating compartment spacers.

In another embodiment, the present invention provides a method for purifying water. The method comprises the step of passing water to be purified through an electrodeionization device comprising a depleting compartment spacer, a concentrating compartment spacer and a water-tight seal comprising an elastomeric sealing member disposed within a groove formed on a surface of either the depleting compartment and or the concentrating compartment spacers.

In another embodiment, the present invention is directed to an electrodeionization device. The electrodeionization device comprises a depleting compartment spacer and a concentrating compartment spacer separated by an ion selective membrane, a primary seal positioned between the depleting compartment and the concentrating compartment spacers and securing the ion selective membrane and a secondary seal positioned between the depleting compartment and the concentrating compartment spacers.

In another embodiment, the present invention provides a method for facilitating water purification. The method comprises the step of providing an electrodeionization device comprising a depleting compartment spacer and a concentrating compartment spacer and a water-tight seal positioned between the depleting compartment and the concentrating compartment spacers.

In another embodiment, the present invention provides a method for facilitating water purification. The method comprises the step of providing an electrodeionization device comprising a depleting compartment spacer having a groove formed on a side thereon, a concentrating compartment spacer and a resilient member disposed within the groove forming a water-tight seal between the depleting compartment and the concentrating compartment spacers.

In another embodiment, the present invention provides a method for facilitating water purification. The method comprises the step of providing an electrodeionization device comprising a spacer constructed of a material that is dimensionally stable at a temperature greater than about 65° C.

In another embodiment, the present invention is directed to an electrodeionization device. The electrodeionization device comprises a spacer constructed of a material that is dimensionally stable at a temperature greater than about 65° C.

In another embodiment, the present invention provides a method for facilitating inactivation of microorganisms. The method comprises the steps of providing an electrodeionization device fluidly connectable to a heating device and providing a controller for regulating a flow and a temperature of water at a pharmaceutically acceptable level in the electrodeionization device.

In another embodiment, the present invention provides a method for inactivating microorganisms. The method comprises the steps of passing water through a depleting compartment at a pharmaceutically acceptable sanitization temperature and maintaining the pharmaceutically acceptable sanitization temperature for a predetermined period of time.

In another embodiment, the present invention provides a method for inactivating microorganisms. The method comprises the steps of passing water through a concentrating compartment at a pharmaceutically acceptable sanitization temperature and maintaining the pharmaceutically acceptable sanitization temperature for a predetermined period of time.

Other advantages, novel features and objects of the invention will become apparent from the following detailed description of the invention when considered in conjunction with the accompanying drawings, which are schematic and are not intended to be drawn to scale. In the figures, each identical, or substantially similar component that is illustrated in various figures is represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

Preferred, non-limiting embodiments of the present invention will be described by way of example and with reference to the accompanying drawings, in which:

FIG. 1 is an exploded view of an electrodeionization device according to one embodiment of the invention;

FIG. 2 is a cross-sectional view of an electrodeionization device of the present invention showing a depleting compartment between a concentrating department; and

FIG. 3 is a graph showing rinse up curves after hot water cycling of the electrodeionization device of Example 2 showing the conductivity of purified water as a function of time.

### DETAILED DESCRIPTION

The present invention is directed to a water purification system for providing purified water for industrial, commercial and residential applications. The purification system includes an electrodeionization device which can comprise one or a plurality of stages. The electrodeionization device can be constructed with a resilient sealing member forming a water-tight seal between rigid thermally and dimensionally stable compartment spacers. The construction of the electrodeionization device allows hot water cycling, which, in some cases, improves its efficiency and performance. Moreover, the hot water cycling may be used to sanitize the device to a pharmaceutically acceptable condition and, preferably, to meet at least minimum requirements according to U.S. Pharmacopoeia guidelines by inactivating any microorganisms. An anode is positioned at an opposite end of a stack of depleting and concentrating compartments from within which a cathode is positioned. Each anode and cathode is provided with an electrode spacer and an ion selective membrane wherein an electrolyte passes through the electrode spacer.

The liquid, typically water, to be purified can be passed in parallel through each depleting compartment and a second liquid can be passed through each concentrating compartment in each stage to effect removal of ions or ionic species with the first liquid in depleting compartment into the second liquid in the concentrating compartment. Electrolytes may be passed through the spacer adjacent each electrode in the electrodeionization device. Other possible flow arrangements are possible. For example, counter-curve flow and reverse flow are shown such as those disclosed by, for example, Giuffrida et al. in U.S. Pat. No. 4,632,745, which is incorporated by reference in its entirety.

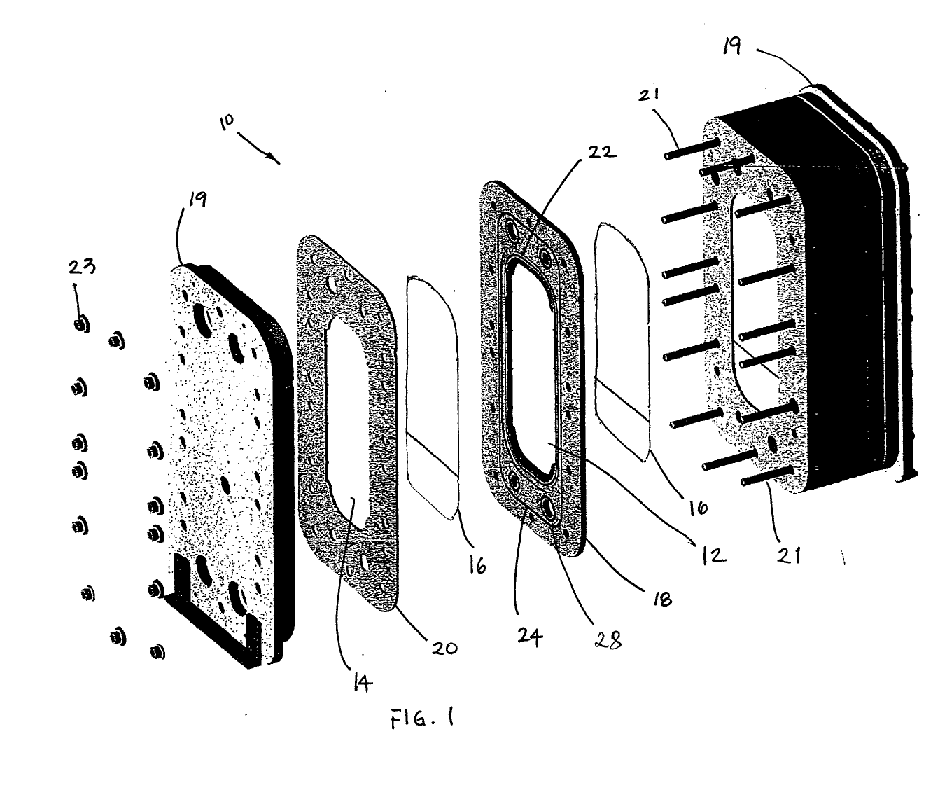

FIG. 1 shows an exploded view of an electrodeionization device according to one embodiment of the present invention. The electrodeionization device 10 includes a depleting compartment 12 and a concentrating compartment 14. Ion-selective membranes typically form the border between the depleting compartment 12 and concentrating compartment 14. Electrodeionization device 10 typically includes a plurality of depleting compartments 12 and concentrating compartments 14 arranged as a stack. Depleting compartment 12 is typically defined by a depleting compartment spacer 18 and concentrating compartment 14 is typically defined by a concentrating compartment spacer 20. An assembled stack is typically bound by end blocks 19 at each end and is typically assembled using tie rods 21 secured with nuts 23. In certain embodiments, the compartments include cation-selective membranes and anion-selective membranes, which are typically peripherally sealed to the periphery of both sides of the spacers. The cation-selective membranes and anion-selective membranes typically comprise ion exchange powder, a polyethylene powder binder and a glycerin lubricant. In some embodiments, the cation- and anion-selective membranes are heterogeneous polyolefin-based membranes, which are typically extruded by a thermoplastic process using heat and pressure to create a composite sheet.

Depleting compartment 12 and concentrating compartment 14 may be filled with ion exchange resin (not shown). In some embodiments, the depleting and concentrating compartments may be filled with cation exchange and anion exchange resins. The cation exchange and anion exchange resins may be arranged in a variety of configurations within each of the depleting and concentrating compartments. For example, the cation exchange and anion exchange resins can be arranged in layers so that a number of layers in a variety of arrangements can be constructed. Other embodiments or configurations are believed to be within the scope of the invention including, for example, the use of mixed bed ion exchange resins in any of the depleting, concentrating and electrode compartments, the use of inert resins between layer beds of anion and cation exchange resins, the use of various types of anionic and cationic resins including, but not limited to, those described by DiMascio et al., in U.S. Pat. No. 5,858,191, which is incorporated by reference in its entirety.

In operation, liquid to be purified, typically having dissolved cationic and anionic components, is introduced into the depleting compartment 12. An applied electric field across the electrodeionization device promotes migration of ionic species in a direction towards their respective attracting electrodes. Under the influence of the electric field, cationic and anionic components leave the depleting compartments and migrate into the concentrating compartments. Ion selective membranes 16 block migration of the cationic and anionic species to the next compartment.

In some embodiments, the applied electric field on electrodeionization device 10 creates a polarization phenomenon, which typically leads to the dissociation of water into hydrogen and hydroxyl ions. The hydrogen and hydroxyl ions may regenerate the ion exchange resins so that removal of dissolved ionic components can occur continuously and without a step for regenerating exhausted ion exchange resins as a result of ionic species migration. The applied electric field across electrodeionization device 10 is typically a direct current. However, any applied current that creates a bias or potential difference between one electrode and another can be used to promote migration of the ionic species.

The ion exchange resin typically utilized in the depleting and concentrating compartments can have a variety of functional groups on their surface regions including, but not limited to, tertiary alkyl amino groups and dimethyl ethanol amine. These can also be used in combination with ion exchange resin materials having other functional groups on their surface regions such as ammonium groups. Other modifications and equivalents that may be useful as ion exchange resin material are considered to be within the scope of those persons skilled in the art using no more than routing experimentation. Other examples of ion exchange resin include, but are not limited to, DOWEX® MONOSPHERE™ 550A anion resin, MONOSPHERE™ 650C cation resin, MARATHON™ A anion resin, and MARATHON™ C cation resin, all available from the Dow Chemical Company (Midland, Mich.). Representative suitable ion selective membranes include homogenous-type web supported styrene-divinyl benzene-based with sulphonic acid or quaternary ammonium functional groups, heterogeneous type web supported using styrene-divinyl benzene-based resins in a polyvinylidene fluoride binder, homogenous type unsupported-sulfonated styrene and quarternized vinyl benzyl amine grafts of polyethylene sheet.

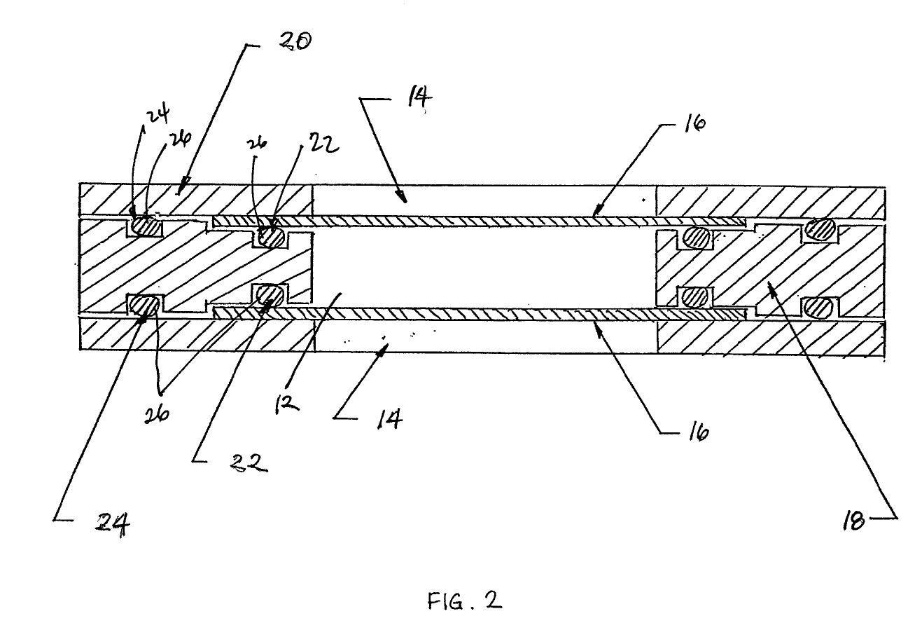

To prevent leakage from the depleting compartment to the concentrating compartment and vice versa, the ion selective membrane sandwiched between depleting compartment and concentrating compartment spacers must form a substantially water-tight seal. Typically, the spacers and the ion selective membranes are compressed together and fixed in position with nuts 23 and tie bars 21. In one embodiment of the present invention, as shown in the cross-sectional view of FIG. 2, depleting compartment 12, between concentrating compartments 14, is. defined by the cavity formed by depleting compartment spacer 18 and ion-selective membranes 16. Concentrating compartment 14 is a cavity defined by concentrating compartment spacer 20 and by selective membranes 16. Also shown in the embodiment of FIG. 2, two water-tight seals 22 and 24 prevent leakage from and between depleting compartment 12 and concentrating compartment 14. Seals 22 and 24, positioned between the depleting compartment and concentrating compartment spacers comprise of a resilient sealing member disposed within a groove that is formed on a surface of the depleting compartment spacer. In another embodiment, the present invention provides a rigid depleting compartment spacer having a groove formed on one side of the spacer that is disposed around a perimeter of depleting compartment 12 or concentrating compartment 14. Resilient sealing member 26 is dimensionally constructed to fit and compress within the groove formed on the surface of the spacer.

As shown in FIG. 2, grooves are formed on a surface of depleting compartment spacer 18. However, other embodiments are considered to be within the scope of the present invention. For example, electrodeionization device 10 may include a single seal comprising a groove defined on the surface of the concentrating compartment spacer 20 with a resilient sealing member disposed and compressed therein thereby forming a water-tight seal between depleting compartment spacer 18 and concentrating compartment spacer 20. The present invention also contemplates the use of a plurality of seals such as primary seal 22 with secondary seal 24.

In another embodiment, the invention provides port seals 28 that form a water-tight seal, around fluid ports, between adjacent spacers. Port seals 28 typically comprise a resilient sealing member, similar to resilient sealing member 26, compressed within a groove surrounding the fluid connection ports. Thus, as assembled, the resilient sealing member prevents leaks to and from the fluid port.

In another embodiment, the present invention provides the use of thermally stable materials that are suitable for thermal cycling. As defined herein, a “thermally suitable material” is one that can maintain its dimensional stability, having no significant change in dimension or shape or mechanical properties under the influence of temperature and pressure. Accordingly, in one embodiment, the present invention contemplates the use of rigid polymeric or non-metallic materials. Examples of polymeric materials include, but are not limited to, polysulfone, polyphenylsulfone, polyphenylene oxide, polyphenylene ether, chlorinated poly(vinyl chloride), polyphenylene sulfide, polyetherimide, polyetherketone, polyamide-imide and polybenzimidazole and mixtures thereof. Resilient sealing member 26 may be formed from any material such as an elastomer including, for example, silicon, polyisobutylene, ethylene-propylene, chlorosulfonated polyethylene, polyurethane and any chlorinated elastomer that is chemically inert and thermally stable to 80° C.

In operation, the electrodeionization device 10 may be disinfected or sanitized by introducing a disinfectant solution to inactivate any microorganisms present within electrodeionization device 10. As used herein, an inactivated microorganism is one that is destroyed or killed or otherwise incapable of propagating into or forming other like organisms. While there is no United States Pharmacopoeia specification for bacterial or microorganisms, the recommended action level limit is 100 colony forming units per milliliter for Purified Water. Thus, in another embodiment, the present invention provides disinfection of an electrodeionization device by the use of hot water to inactivate any microorganisms. According to one embodiment, hot water sanitization may be performed by passing or circulating water through the electrodeionization device and maintaining circulation of the water at the pharmaceutically acceptable sanitization temperature for a predetermined period of time. A pharmaceutically acceptable sanitization temperature is one wherein any microorganisms exposed to such a temperature are inactivated and in particular to one wherein the microorganisms are inactivated to below the acceptable action limit. Thus, in one embodiment, the present invention provides circulating hot water having a temperature of at least about 65° C. and in another embodiment, the present invention provides the use of hot water to sanitize an electrodeionization device at a temperature of about 80° C.

The function and advantage of these and other embodiments of the present invention can be further understood from the examples below. The following examples are intended to illustrate the benefits of the present invention but do not exemplify the full scope of the invention.

### EXAMPLES

### Example 1

Two electrodeionization devices, depicted in the exploded view of FIG. 1 and in the cross-sectional view of FIG. 2, were constructed. One electrodeionization device had a stack of 10 depleting compartments and concentrating compartments secured and held together by tie rods and nuts. The other electrodeionization device had a stack of 24 depleting and concentrating compartments. Depleting compartment spacer 18 and the concentrating compartment spacers 20 were molded using a rigid polymer available as RADEL® R-5100 polyphenylsulfone from BP Amoco Chemicals (Alpharetta, Ga.). A primary seal and a secondary seal were formed on opposite surfaces of the depleting compartment spacer. The primary seal included a groove and a resilient sealing member, in particular, an O-ring surrounding the cavity forming the depleting compartment. Upon assembly, resilient sealing members were compressed within the groove to form water-tight seals. The resilient sealing member was formed from an elastomeric material, having a lower hardness than the material forming the depleting compartment and concentrating compartment spacers. In particular, the resilient sealing members 26 were formed from silicone elastomer and buna-N elastomer.

### Example 2

An electrodeionization device having 10 depleting and concentrating compartment pairs was constructed as described above to evaluate performance. The test system comprised of a hot water source in closed loop with the electrodeionization device. The electrodeionization device was cycled approximately three times per day with deionized water. The feed pressure into the electrodeionization device ranged from between 3-5 psig, with a dilute flow of 1 to 1.5 gallons per minute and a concentrate flow of 0.75 to 1.0 gallons per minute.

The typical sanitization cycle (HWS) comprised of a one hour ramp up from 27° C. to 80° C., a one hour soak at 80° C. and a 20-30 minute cool down to 20° C. The electrodeionization device was allowed to sit at 27° C. for about 10 minutes before starting the next sanitization cycle.

After 7, 25, 52, 104 and 156 cycles, the electrodeionization device was checked for cross-leaks, and operated to evaluate changes in the rinse up of curve. Rinse up shows how the quality of product increases as a function of time. After running for approximately 24 hours, the electrodeionization device was re-exposed to the sanitization cycles. The first three tests were performed with feed water temperature of below 10° C. while the later three tests were performed at 15° C. and 20° C.

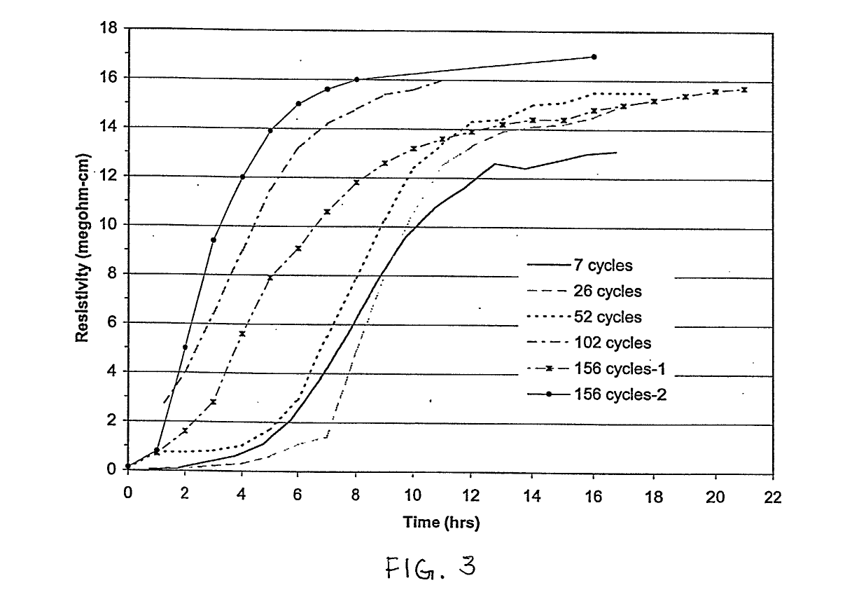

FIG. 3 shows the resistivity, the quality of water, as a function of time after 7, 26, 52, 102 and 156 cycles. Notably, FIG. 3 shows that the resistivity or the quality of the product water improved after or with increasing number of hot water cycles. This also showed that the electrodeionization device can be used at higher temperatures without component damage. In particular, this shows that the resin (rated up to 60° C.) was suitable for sanitization cycles to 80° C. without a loss in electrodeionization device performance.

### Example 3

An electrodeionization device was constructed as described above and hot water sanitized as described above in Example 2 to evaluate the effect of HWS on biological activity. Initially, the electrodeionization device was placed on standby for about 6 days to increase the bacterial activity. Samples were taken before, during and subsequent to sanitization at 80° C. and measured for colony forming units. Table 1 shows that during the hot water procedure, the concentration of colony forming units decreased.

TABLE 2

| Sample | | Mean |
|---|---|---|
| No | Sample | (CFU/ml) |
| 1 | Feed. Power off. Recirculate 10 mins | >5000 |
| 2 | Product. Power off. Recirculate 10 mins | >5000 |
| 3 | Feed. Power off. Recirculate 30 mins | 1357 |
| 4 | Product. Power off. Recirculate 30 mins | 1188 |
| 5 | Feed. Power on, recirculate 30 mins | 1015 |
| 6 | Product. Power on, recirculate 30 mins | 221 |
| 7 | Feedwater/tank mid-sanitization cycle | <0.1 |
| | 80° C. | |
| 8 | Feedwater/tank after sanitization cycle | 1.3 |
| | 72° C. | |
| 9 | Feed after cool down w/RO permeate, | 69 |
| | Power on, single pass | |
| 10 | Product after cool down w/RO permeate, | 21 |
| | Power on, single pass | |

### Example 4

Two electrodeionization devices, a 10-cell and a 24-cell stack, were assembled as described above in Example 1. The electrodeionization devices were exposed to HWS at 80° C. as described in Example 2. Tables 2 and 3, listed below, summarize the operating conditions and performance of the devices and show that the product quality, as measured by resistivity, increased after exposure to hot water cycling.

TABLE 2

| 24-cell | | |
|---|---|---|
| PARAMETER | Before HWS | After 2 HWS |
| Feed conductivity, μS/cm | 10.7 | 7.2 |
| Feed CO₂, ppm | 16-19 | 16-19 |
| Feed temperature, ° C. | 15-18.5 | 16-17 |
| DC volts | 193 | 205 |
| DC amps | 9.8 | 10.3 |
| Product flow, 1/hr | 2000 | 2000 |
| Product resistivity, Megohm-cm | 7.1 | 15.2 |

TABLE 3

| 10-cell | | |
|---|---|---|
| PARAMETER | Before HWS | After 1 HWS |
| Feed conductivity, μS/cm | 1.2 | 1.1 |
| Feed CO₂, ppm | 2.5 | 2.5 |
| Feed temperature, ° C. | 15.2 | 16.1 |
| DC volts | — | 40 |
| DC amps | 3 | 3 |
| Product flow, 1/hr | 1000 | 1000 |
| Product resistivity, Megohm-cm | 15.8 | 18.1 |

Those skilled in the art would readily appreciate that all parameters and configurations described herein are meant to be exemplary and that actual parameters and configurations will depend on the specification application for which the systems and methods of the present invention are used. Those skilled in the art should recognize or be able to ascertain using no more than routine experimentation many equivalents to the specific embodiments of the invention described herein. For example, the present invention includes the use of a primary or a secondary water-tight seal that may be constructed or formed on either the depleting compartment or concentrating compartment spacers by any known technique such as molding or machining the grooves. It is, therefore, to be understood that the further embodiments are presented by way of example only and that, within the scope of the appended claims and equivalents thereto, the invention may be practiced otherwise as specifically described. The invention is directed to each individual feature, system, or method described herein. In addition, any combination of two or more such features, systems, or methods provided at such features, systems, or methods that are not mutually inconsistent, is included within the scope of the present invention.

What is claimed is:

1. A method for inactivating microorganisms in an electrodeionization device comprising:
passing water through the electrodeionization device at a pharmaceutically acceptable sanitization temperature; and
maintaining the pharmaceutically acceptable sanitization temperature for a predetermined period of time.

2. The method of claim 1, wherein the step of maintaining the water temperature is performed until there is a pharmaceutically acceptable level of microorganisms in the electrodeionization device.

3. The method of claim 1, wherein the water temperature is maintained at greater than about 65° C.

4. The method of claim 1, wherein the water temperature is maintained at about 80° C.

5. The method of claim 1, further comprising the step of lowering the water temperature to less than about 30° C.

6. A water purification system comprising:
an electrodeionization device fluidly connected to a heating device; and
a controller for regulating a flow and temperature of water at a pharmaceutically acceptable level in the electrodeionization device.

7. The water purification system of claim 6, wherein the water temperature is regulated to at least about 65° C.

8. The water purification system of claim 6, wherein the water temperature is regulated to about 80° C.

9. The water purification system of claim 6, wherein the water temperature is regulated until the electrodeionization device has been sanitized to satisfy pharmaceutical requirements.

10. The water purification system of claim 6, wherein the electrodeionization device comprises a spacer comprising at least one of polysulfone, polyphenylsulfone, polyphenylene oxide, polyphenylene ether and chlorinated poly(vinyl chloride).

11. A method for disinfecting an electrodeionization device comprising:
passing a disinfecting solution at a temperature sufficient to inactivate any microorganisms in the electrodeionization device.

12. The method of claim 11, wherein the step of passing the disinfecting solution is performed until the electrodeionization device is sanitized to a pharmaceutically acceptable condition.

13. The method of claim 11, wherein the disinfecting solution has a temperature that is suitable for sanitizing the electrodeionization device for pharmaceutical service.

14. The method of claim 11, wherein the temperature is at least about 65° C.

15. The method of claim 11, wherein the temperature is about 80° C.

16. The method of claim 11, further comprising the step of passing water to be purified through the electrodeionization device.

17. The method of claim 11, wherein the step of passing the disinfecting solution is performed until there is a pharmaceutically acceptable level of microorganisms in the electrodeionization device.

18. The method of claim 11, further comprising the step of passing a biocide compound through the electrodeionization device.

19. The method of claim 11, wherein the disinfecting solution consists essentially of a non-oxidizing compound.

20. An electrodeionization device comprising a spacer constructed of a material that is dimensionally stable at a temperature that sanitizes the electrodeionization device for pharmaceutical service.

21. The electrodeionization device of claim 20, wherein the material is dimensionally stable at greater than about 65° C.

22. The electrodeionization device of claim 20, wherein the dimensionally stable material comprises at least one of polysulfone, polyphenylsulfone, polyphenylene oxide, polyphenylene ether and chlorinated poly(vinyl chloride).

23. A method for purifying water comprising:
passing water to be purified through the electrodeionization device; and
passing water at a temperature greater than about 65° C. through the electrodeionization device for a predetermined period.

24. The method of claim 23, wherein the water temperature is at least about 80° C.

25. The method of claim 23, further comprising the step of reversing polarity of an applied electric field through the electrodeionization device.

26. An electrodeionization device comprising:
a rigid depleting compartment spacer having a groove formed on a side thereon;
a rigid concentrating compartment spacer that mates with the depleting compartment spacer; and
a resilient member disposed within the groove forming a water-tight seal between the depleting compartment and the concentrating compartment spacers.

27. The electrodeionization device of claim 26, wherein the groove is disposed around the perimeter of the depleting compartment spacer.

28. The electrodeionization device of claim 26, wherein the depleting compartment spacer has grooves formed on both sides thereon.

29. The electrodeionization device of claim 26, wherein the resilient member comprises at least one of a fluorinated elastomer and a silicone elastomer.

30. A method for purifying water comprising:
passing water to be purified through an electrodeionization device comprising a depleting compartment spacer having a groove formed on a side thereon, a concentrating compartment spacer and a resilient member disposed within the groove forming a water-tight seal between the depleting compartment and the concentrating compartment spacers; and
applying an electric field across the electrodeionization device.

31. An electrodeionization device comprising:
a depleting compartment spacer;
a concentrating compartment spacer; and
a water-tight seal positioned between the depleting compartment and the concentrating compartment spacers,
wherein the water-tight seal comprises an elastomeric sealing member disposed within a groove formed on a surface of either the depleting compartment or the concentrating compartment spacers.

32. The electrodeionization device of claim 31, wherein the depleting compartment spacer and the concentrating compartment spacer comprises a rigid material.

33. The electrodeionization device of claim 32, wherein the depleting compartment spacer comprises at least one of polysulfone, polyphenylsulfone, polyphenylene oxide, polyphenylene ether and chlorinated poly(viny chloride).

34. A method for purifying water comprising:
passing water to be purified through an electrodeionization device comprising a depleting compartment spacer, a concentrating compartment spacer and a water-tight seal comprising an elastomeric sealing member disposed within a groove formed on a surface of either the depleting compartment or the concentrating compartment spacers.

35. An electrodeionization device comprising:
a depleting compartment spacer and a concentrating compartment spacer separated by an ion selective membrane;
a primary seal positioned between the depleting compartment and the concentrating compartment spacers and securing the ion selective membrane; and
a secondary seal positioned between the depleting compartment and the concentrating compartment spacers.

36. The electrodeionization device of claim 35, wherein the primary seal comprises an elastomeric sealing member dimensioned to be disposed within a groove formed between mating surfaces of the depleting compartment and the concentrating compartment spacers.

37. The electrodeionization device of claim 35, wherein the secondary seal comprises an elastomeric sealing member dimensioned to be disposed within a groove formed between mating surfaces of the depleting compartment and the concentrating compartment spacers.

38. A method for facilitating water purification comprising providing an electrodeionization device comprising a depleting compartment spacer and a concentrating compartment spacer and a water-tight seal positioned between the depleting compartment and the concentrating compartment spacers.

39. A method for facilitating water purification comprising providing an electrodeionization device comprising a depleting compartment spacer having a groove formed on a side thereon, a concentrating compartment spacer and a resilient member disposed within the groove forming a water-tight seal between the depleting compartment and the concentrating compartment spacers.

40. A method for facilitating water purification comprising providing an electrodeionization device comprising a spacer constructed of a material that is dimensionally stable at a temperature greater than about 65° C.

41. An electrodeionization device comprising a spacer constructed of a material that is dimensionally stable at a temperature greater than about 65° C.

42. A method for facilitating inactivation of microorganisms comprising:
providing an electrodeionization device fluidly connectable to a heating device; and
providing a controller for regulating a flow and a temperature of water at a pharmaceutically acceptable level in the electrodeionization device.

43. A method for inactivating microorganisms in an electrodeionization device comprising:
passing water through a depleting compartment at a pharmaceutically acceptable sanitization temperature; and
maintaining the pharmaceutically acceptable sanitization temperature for a predetermined period of time.

44. A method for inactivating microorganisms in an electrodeionization device comprising:
passing water through a concentrating compartment at a pharmaceutically acceptable sanitization temperature; and
maintaining the pharmaceutically acceptable sanitization temperature for a predetermined period of time.
